(19) United States
(12) Patent Application Publication
(10) Pub. No.: US 2024/0389549 A1
(43) Pub. Date: Nov. 28, 2024

(54) INVERTIBLE PET FEEDER APPARATUS

(71) Applicant: Verna M. Stout, Myrtle Beach, SC (US)

(72) Inventor: Verna M. Stout, Myrtle Beach, SC (US)

(21) Appl. No.: 18/201,851

(22) Filed: May 25, 2023

(51) Int. Cl. A01K 5/01; A01K 7/00

(52) U.S. Cl. CPC A01K 5/0114; A01K 7/00

(57) ABSTRACT

A pet feeder apparatus includes a pair of containers each for storing pet food or water, wherein each container includes a removable lid, the first container is releasably attached to the second container in a stacked fashion via an attachment mechanism. The lower container engaged against the floor is oriented in an upside-down orientation, and the upper container is oriented in an upright orientation, thereby providing an invertible functionality to the apparatus whereby the user may orient and reorient the apparatus between the upper container and the lower container positioned in the upright orientation.

### I. RELATED APPLICATIONS

There are no previously filed, nor currently any co-pending applications, anywhere in the world.

### II. FIELD OF THE INVENTION

The present application discloses claims and embodiments generally related to a pet feeder apparatus, and in particular, a pet feeder apparatus that may be inverted for extended usage.

### III. BACKGROUND OF THE INVENTION

Numerous attempts have been made to improve food containers and container systems. Although not exhaustive, the following references serve as a representation of the improvements in such containers.

U.S. Pat. No. 7,832,586 B2, issued in the name of Vovan. Vovan discloses a multi-compartment food packaging containment system that includes a large base tray compartment and a lid member comprising a plurality of smaller compartments that hold a variety of foodstuffs. Vovan further discloses tray members 108 may be stacked on top of one another. (See Col. 6, lines 18-27, and FIG. 18).

U.S. Patent Publication No. 2011/0091614 A1, published in the name of Malone et al. that discloses a container system which includes a lower container for receiving a first food component (or components) and an upper container assembly for receiving a second food component (or components) and includes a seal member 130 separated from the first food component 104 by pulling a pull tab 142, thereby revealing an orifice 128 through the seal member 130 through which the second food component 108 from the upper container assembly 106 is introduced into the lower container 102 with the first food component 104.

Malone et al. discloses, in relevant part, “ . . . the upper container assembly 106 includes a pull tab 142 that is pulled to separate (e.g., peel back) the seal member 130 from the lip 124 of the upper container assembly 106. In this manner, the second food component 108 is released from the interior cavity 126 of the upper container assembly 106 into the lower container 102 through orifice 128. (See paragraph [0059], and FIGS. 3B & 3C).

U.S. Pat. No. 5,205,242, issued in the name of Kasselman, which discloses a pet food container having a dish member with a concavity formed therein and a base member having a liquid-receiving moat formed therein; the dish member has a connector formed on a bottom surface of the concavity which is detachably engageable with a central member formed on the base member that is a raised rim extending outwardly from an outer periphery of the bottom surface and also includes an upper surface above the concavity with a configuration which is nestable within the moat of the base member; and a clamp is provided in resilient relationship with the base member so as to extend through a hole in the base member between a retracted position and an extended position.

U.S. Patent Publication No. 2008/0314326 A1, published in the name of Albert, which discloses a portable, disposable, lightweight container is provided for carrying and storing pet food and water in a manner that enables a pet owner to prepare or purchase prepackaged water or food for a pet, and then provide the food or water to a pet or companion animal when away from the normal place of feeding the animal, such as when traveling; the container is sized with an opening sufficient to receive the muzzle, snout or beak of the animal, and includes a lid and means for carrying and stacking the container.

U.S. Pat. No. 10,772,291 B2, issued in the name of Grinnell et al., which discloses a portable pet feeder and supply storage apparatus has a first compartment having a base and sidewalls defining a first open space; a second compartment having a lid and sidewalls defining a second open space; a divider interposed between the first and second compartments, wherein the second compartment and the divider are hinged to the first compartment, the divider has a gasket; wherein the second compartment and the divider may be pivoted towards the first compartment to assume a closed position, the gasket on the divider providing a water-tight seal between the first compartment and the divider; a water dish and a food dish both removably insertable within the first open space; at least one removable container receivable within the second open space, the removable container configured to be refillable and water-tight; and wherein the second compartment and the divider are removably attachable to the first compartment.

U.S. Patent Publication No. 2003/0026876 A1, published in the name of Albuja et al., which discloses an improved pet food snack and container for holding same and for providing and dispensing a dry pet food snack in combination with a highly palatable paste or sauce is provided, wherein the container houses separate first and second pet foods; the container has a removable lid that automatically places the first and second pet foods into contact when the lid is removed and includes a bowl that holds the contacted first and second pet foods.

U.S. Patent Publication No. 2018/0312323 A1, published in the name of North, which describes a cooler buddy for food storage that also has the capability of floating in a body of water.

Accordingly, a need continues to exist and is recognized for improvements to pet feeder apparatuses.

This application presents claims and embodiments that fulfill a need or needs not yet satisfied by the products, inventions, systems, and methods previously or presently available. In particular, the claims and embodiments disclosed herein describe an invertible pet feeder apparatus, the apparatus comprises a pair of containers comprising a first container and a second container, the first container releasably attachable to the second container via an attachment means and forming a stacked relationship between the first container and the second container, and wherein each of the first container and the second container comprises an interior cavity for storing food or water, and wherein each of the first container and the second container comprises a lid detachably secured to a lip of each the first container and the second container, the invertible pet feeder apparatus providing unanticipated and nonobvious combination of features distinguished from the products, devices, apparatuses, inventions, systems, and methods preexisting in the art. The applicant is unaware of any device, apparatus, method, system disclosure or reference that discloses the features of the claims and embodiments disclosed herein.

### IV. SUMMARY OF THE INVENTION

In comparison to the identified references, and in sharp contrast to the present invention, the references fail to teach, suggest, or disclose either separately or in combination the elements as recited in this disclosure and claimed herewith. For example, the references fail to teach the elements recited in this disclosure, and particularly fails to teach that a first container releasably attached to the second container in a stacked fashion via an attachment means such that the second (lower) container is engaged against the floor in an upside-down orientation, and the first (upper) container is oriented in an upright orientation, and wherein the apparatus may be inverted while in an attached configuration such that the first container is engaged against the floor in an upside-down orientation, and the second is oriented in an upright orientation and provides an elevated feeding bowl from which a pet eats/drinks. Moreover, in further contrast to the present invention, the reference fails to teach, suggest, or disclose releasably attachable lids constructed of a semi-rigid, slip-resistant material of suitable square inch surface area so as to stabilize and immobilize the apparatus when a selected lid is engaged superjacent a flat surface (such as a floor) during pet feeding periods.

Generally, according to a broadly described embodiment, a pet feeder apparatus includes a pair of containers each for storing pet food or water, wherein each container includes a removable lid, the first container is releasably attached to the second container in a stacked fashion via an attachment mechanism (e.g., Velcro®), the lower container engaged against the floor is oriented in an upside-down orientation, and the upper container is oriented in an upright orientation, thereby providing an invertible functionality to the apparatus whereby the user may orient and reorient the apparatus between the upper container and the lower container positioned in the upright orientation; the first container and the second container each includes a transparent base member having an outer periphery from which a sidewall integrally extends upwardly forming an interior cavity, the sidewall terminates in a curved lip forming an open top which may be closed by a respective lid.

More particularly, and in one embodiment, an invertible pet feeder apparatus comprises a pair of containers comprising a first container and a second container, the first container releasably attachable to the second container via an attachment means and forming a stacked relationship between the first container and the second container, and wherein each of the first container and the second container comprises an interior cavity for storing food or water, and wherein each of the first container and the second container comprises a lid detachably secured to the lip.

In another embodiment, an invertible pet feeder apparatus comprises a pair of containers comprising a first container and a second container, the first container releasably attachable to the second container via an attachment means and forming a stacked relationship between the first container and the second container; each of the first container and the second container comprises a transparent base member that has an outer periphery from which a sidewall integrally extends upwardly and forming an interior cavity, and the sidewall terminates in a lip forming an open top fluid communication with an interior cavity; and, each of the first container and the second container comprises a lid detachably secured to the lip, wherein each lid comprises non-skid material.

In another embodiment, an invertible pet feeder apparatus comprises a pair of containers comprising a first container and a second container, the first container releasably attachable to the second container via an attachment means and forming a stacked relationship between the first container and the second container measuring at least 4.00 inches in height as measured from a floor surface. In reference to domestic cats, it is critical to the present invention that the first container is releasably attachable to the second container via an attachment means and forming a stacked relationship measuring approximately between 4.00 inches to 6.00 inches in height as measured from a floor surface. In further reference to domestic cats, it is also critical to the present invention that each of the first container and the second container comprises a width measure of at least 6.25 inches. Each of the first container and the second container comprises a transparent base member that has an outer periphery from which a sidewall integrally extends upwardly and forming an interior cavity, and the sidewall terminates in a lip forming an open top fluid communication with an interior cavity.

Indicia may be disposed on the outer periphery of the first container or the second container, and each of the first container and the second container comprises a lid detachably secured to the lip. Each lid is constructed of or otherwise comprises non-skid material disposed on the obverse surface in a quantity sufficient for inhibiting excessive movement of the apparatus during use.

Applicable to all the disclosed embodiments above, each apparatus may further comprise at least one additional container interchangeable with either the first container and the second container.

Applicable to all the disclosed embodiments above, each apparatus may further comprise a partition insertable into either the first container or the second container.

### V. BRIEF DESCRIPTION OF THE DRAWING(S)

The advantages and features of the present invention will become better understood with reference to the following more detailed description and claims taken in conjunction with the accompanying drawings, in which like elements are identified with like symbols, and in which:

FIG. 1 is a front perspective of an invertible pet feeder apparatus depicting a first container positioned at the highest or tallest vertical position;

FIG. 2 is a front perspective an invertible pet feeder apparatus depicting a second container positioned at the highest or tallest vertical position, and inverted position relative to FIG. 1;

FIG. 3 is a perspective view of the first container and the second container decoupled from one another and illustrating one example embodiment of an attachment means;

FIG. 4 is a perspective view of the second container in the tallest vertical position showing the lid thereof removed and providing access to the stored food;

FIG. 5 is a perspective view of the first container in the tallest vertical position showing the lid thereof removed and providing access to the interior of the first container; and

FIG. 5A is an exploded perspective view showing releasable attachment of the first container to the second container via an attachment means, in accordance to another exemplary embodiment.

### VI. DESCRIPTION OF THE EMBODIMENT(S)

It will be readily understood that the components of the present invention, as generally described and illustrated in the figures herein, may be arranged and designed in a wide variety of different configurations. Thus, the following detailed description of the embodiments, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, the usage of the phrases “example embodiments”, “some embodiments”, or other similar language, throughout this specification refers to the fact that a particular feature, structure, or characteristic described in connection with the embodiment may be included in at least one embodiment of the present invention. Thus, appearances of the phrases “example embodiments”, “in some embodiments”, “in other embodiments”, or other similar language, throughout this specification do not necessarily all refer to the same group of embodiments, and the described features, structures, or characteristics may be combined in any suitable manner in one or more embodiments.

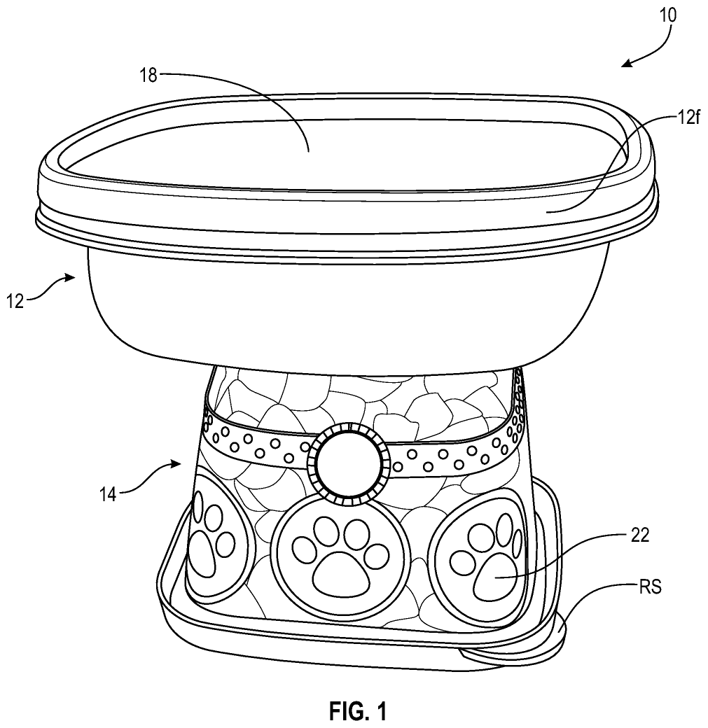

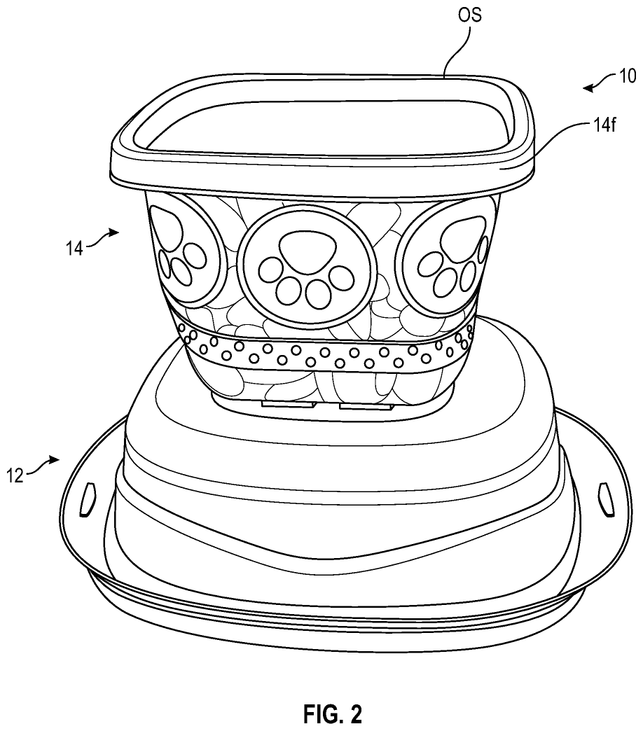

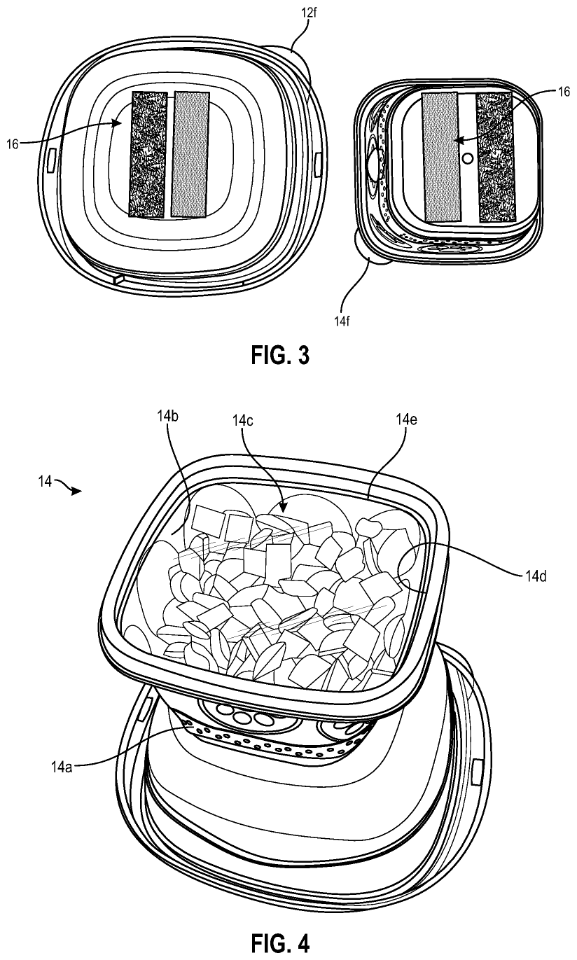

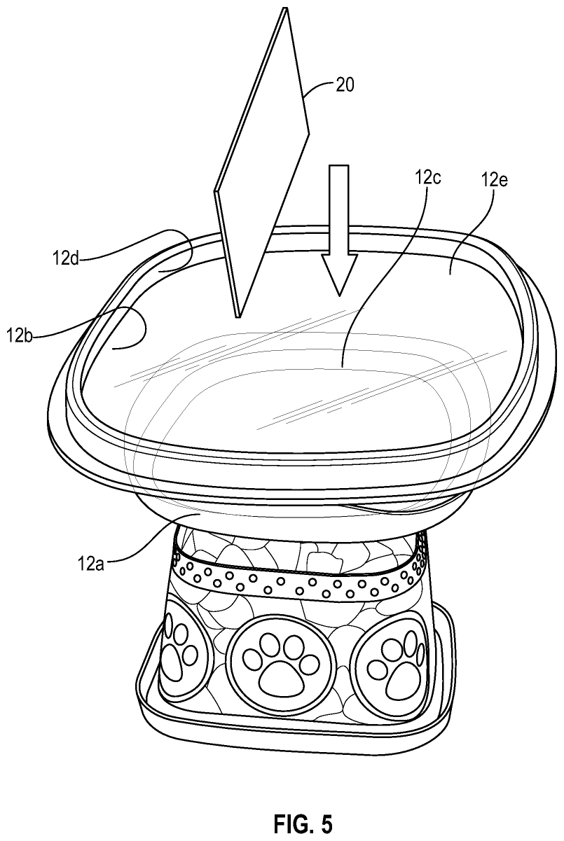

Referring now to FIG. 1 through FIG. 5A, an invertible pet feeder apparatus is disclosed and described, and generally denoted by the reference character 10. The apparatus 10 comprises a pair of containers comprising a first container 12 and a second container 14. The first container 12 is releasably attached to the second container 14 in a stacked fashion via an attachment means (such as a hook-and-loop fastening system) 16. The first container 12 and the second container 14 each comprises a transparent base member 12a, 14a that has an outer periphery from which a sidewall 12b, 14b integrally extends obtusely upwardly forming an interior cavity 12c, 14c. The sidewall 12b or 14b terminates in a curved lip 12d, 14d forming an open top 12e, 14e in open fluid communication with the interior cavity 12c, 14c. The first container 12 and the second container 14 each comprises a lid 12f, 14f detachably secured to the lip 12d, 14d, respectively, thereof, in an air-tight, sealed fashion.

The lid 12f, 14f of each the first and second container 12, 14 is constructed of a semi-rigid, slip-resistant material of suitable square inch surface area so as to stabilize and immobilize the apparatus 10 when a selected lid 12f, 14f is engaged superjacent a flat surface (such as a floor) during pet feeding periods, and wherein the attachment means is suitably secured superjacent the outer surface of the transparent base member 12a, 14a of each the first container 12 and the second container 14, respectively, thereby enabling quick, easy, and efficient matched aligned attachment by the complementary attachment means (e.g., hook-and-loop fastener) and releasable attachment of the first container 12 to the second container 14.

In one embodiment, the containers 12 and 14 may comprise similar and/or identical features and dimensions. For example, it is envisioned that containers 12 and 14 may be substantially similar or identical in both form and dimension so that the apparatus 10 is invertible but indistinguishable with regard to orientation. This may be particularly advantageous for servicing either a single pet household or a multi-pet household in which the animals are approximately the same size and where careful delineation between the containers 12, 14 and an associated pet is either unnecessary or of diminished importance. In such an embodiment, each container 12 (and/or 14) has a base 12a (14a), an upwardly depending sidewall 12b (14b), the base(s) and sidewall(s) defining an interior cavity 12c (14c) into which food and/or water may be disposed and stored. The sidewall(s) 12b (14b) terminate in a lip 12d (14d) that assists in defining the opening 12e (14e) for the container(s) 12 (14), wherein the lip 12d (14d) provides a means for coupling with complementary surface features of the lid(s) 12f (14f) to form a sealable and unsealable enclosure, with a preferred air tight seal for maintaining and extending the freshness of the food and/or water stored therein.

In a separate embodiment, the containers 12 and 14 may comprise similar forms but different dimensions. For example, it is envisioned that containers 12 and 14 may be substantially similar or identical in form but the dimensions are defined so that container 12 and the container 14 are sized to service animals of different size. Although the containers 12 and 14 may possess different dimensions, the apparatus 10 is invertible but distinguishable with regard to orientation so that the user may easily prepare service of the associated animals. This may be particularly advantageous for servicing a multi-pet household in which the animals are physically of different sizes. In one such embodiment, and consistent with FIGS. 1 through 5, container 12 may be wider than container 14, wherein container 12 is configured and adapted to service an animal with a wider and/or larger face relative to container 14 that is configured and adapted to service an animal with a relatively narrow and/or smaller face. For example, it is envisioned that container 12 is configured and adapted for servicing an adult cat (e.g., Maine Coon) and the container 14 is configured and adapted for servicing a younger, smaller cat (e.g., a kitten), or two adult cats of visibly different sizes (e.g., Maine Coon for container 12 and Abyssinian for container 14). Likewise, a similar configuration and adaptation might be achieved for adult dogs (container 12) and puppies (container 14), or two adult dogs of visibly different sizes (e.g., Giant Schnauzer for container 12 and Pomeranian for container 14).

An additional advantage of the stackable dual-container orientation of apparatus 10 is the feeding and digestion of the food and/or water provided via the apparatus 10. Because the animal will consume the food/water from an elevated height, with the unused container 12 or 14 forming the base of the feeder apparatus 10, chewing, swallowing, and digesting of the food/water is more easily accomplished, and is especially preferable for ease of digesting pet food. Although it is envisioned that the height of the apparatus 10 may be variable depending on the depth of the container(s) 12 or 14, and with the potential for mixing-and-matching through interchangeable containers of varying sizes, at a minimum, the height is envisioned to be at least 4.00 inches. In a preferable embodiment, the height is approximately between 4.00 inches and 6.00 inches in height.

Moreover, preferably the width of each container 12 and/or 14 is sized to accommodate the head width of the targeted animal. This is particularly concerning for cats, because cats can experience a phenomenon called “whisker fatigue” through persistent, repetitive touch-stimulation of the whiskers. Whisker fatigue can cause discomfort and/or pain, can interrupt the eating and digestive activities, and may cause the feeding session to end prematurely and before the cat experiences fullness. For this reason, it is envisioned that a variety of sizes may be produced and made available to accommodate as many breeds and associated sizes. It is also envisioned that the container 12 and/or 14 may be configured so that it is adjustable, expandable and retractable along a range of diameters and/or circumferences. In one particular embodiment, it is envisioned that the width of the container(s) 12 and/or 14 meet a minimum threshold width of approximately 6.25 inches to accommodate most whisker widths of domestic cat(s) known.

Thus, in particular reference to domestic cats, it is critical to the present invention that the first container is releasably attachable to the second container via an attachment means and forming a stacked relationship measuring approximately between 4.00 inches to 6.00 inches in height, as measured from a floor surface. In further reference to domestic cats, it is also critical to the present invention that each of the first container and the second container comprises a width measure of at least 6.25 inches.

In another embodiment, the apparatus 10 may include at least three containers 12 and/or 14. In such an embodiment, at least one of the containers 12 or 14 is differently sized and/or formed relative to the other two containers 12 and/or 14. Other such variations include an apparatus 10 having more than four containers and the like. In such multi-container embodiments, the additional containers are envisioned to be different from containers 12 and 14 and from one another. Such expanded multi-container embodiments provide greater flexibility to the user and allow for mixing-and-matching variations.

In another embodiment, the lid(s) 12f (14f) include both an obverse surface OS and a reverse surface RS, and when the lid(s) 12f (14f) is/are secured to the container(s) 12 (14) to form an air tight seal, the reverse surface RS is disposed adjacent to the interior cavity(ies) 12c (14c) of the containers 12 (14), and the obverse surface OS is disposed to be visible to the user. The reverse surface RS includes surface features that are complementary to the lip(s) 12d (14d) to allow press fit and/or impingement of the lid(s) 12f (14f) to the lip(s) 12d (14d). The obverse surface OS includes one or more non-skid elements 18. Alternatively, the lid 12f, 14f of each the first and second containers 12 and 14, respectively, are constructed of a non-skid or anti-slip material.

The non-skid element(s) 18 is/are utilized during feeding. Because the lid 12d or 14d remains on the container 12 or 14 that is unused and at the lowest vertical position relative to the used container 12 or 14, the non-skid element(s) 18 on the obverse surface OS of lid 12d or 14d engages with the horizontal surface(s) that temporarily supports the apparatus 10. The non-skid element(s) 18 may comprise a variety of materials that ideally possess a high coefficient of friction relative to most surfaces that the user may encounter, including a variety of floor coverings (rugs, carpets, hard surfaces such as hardwood, stone, laminates, concrete, vinyl, rubber, and the like) or other floor or surface materials. It is envisioned that rubber and rubber-related materials, vinyl foam, polyethylene foam, neoprene, thermoplastics, cork, abrasive (grit) imparted material(s), fiberglass, other related materials and combinations of such materials. Preferably, the non-skid element(s) 18 provide sufficient surface area along the obverse surface OS to prevent excessive rotation and/or unwanted movement of the apparatus 10 during feeding of the pet.

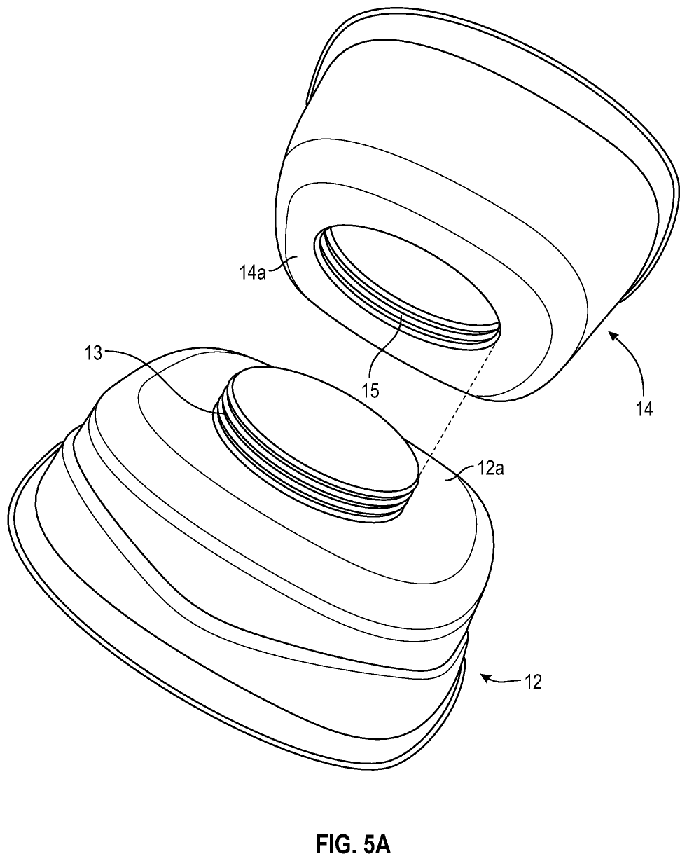

The attachment 16 may comprise a variety of means or mechanisms for achieving removable and/or detachable coupling between the first container 12 and the second containers 14. For example, it is envisioned that hook-and-loop material is a suitable means for attaching the containers 12, 14, whereby one container 12 or 14 includes the hook material and the other container 12 or 14 includes the loop material. Other means that are envisioned as suitable for achieving coupling and decoupling of the containers 12 and 14 include snap-fit or friction-fit impingement features, whereby the coupling and decoupling is achieved through complementary form features. Other means include threadable coupling through the mating of external threads 13 and internal threads 15 separately formed, respectively, along the base member 12a of the container 12 and the base member 14a of the container 14, as depicted in FIG. 5A.

The containers 12 and/or 14 is/are envisioned as adaptable for either integral or removable internal partitions 20. In one such embodiment, the partition(s) 20 serve to provide wells or reservoirs within the container(s) 12 and/or 14 and allow the user to include additional food, water, nutrition, and the like according to preference. This may be particularly advantageous to separate otherwise messy or disparate foods, especially if the mixing of foods creates a flavor profile not wanted or attractive for the pet.

It is envisioned that the apparatus 10 and its attendant elements may be manufactured or formed from a variety of lightweight, durable materials that are capable of repeated usage and cleaning. In particular, it is envisioned that a variety of materials may be used. Such materials may include lightweight, hard plastics and polymers of many varieties, such as including but not limited to, polyolefins, silicone, polyisocyanurate, alkenyl aromatic polymers, cellulosic polymers, polycarbonates, polyetherimides, polyamides, polyesters, polyvinylidene chloride, polymethylmethacrylate, polyurethanes, polyisocyanurates, and phenolics, polychloroprene, neoprene, ethylene-vinyl acetate, thermoplastic urethane, styrene-butadiene rubber, flexible polyvinyl chloride, acrylic/acrylate, polyethylene, and polypropylene, and such other related materials and combinations thereof. Moreover, the apparatus 10 may include exterior surface space (or other visible surface space(s)) that may be utilized for integral and/or applied indicia 22, such as licensed trademarks in the form of word marks, logos, designs, combinations thereof, characters, caricatures, likenesses, images, and combinations thereof.

It is to be understood that the embodiments and claims are not limited in its application to the details of construction and arrangement of the components set forth in the description and illustrated in the drawings. Rather, the description and the drawings provide examples of the embodiments envisioned, but the claims are limited to the specific embodiments. The embodiments and claims disclosed herein are further capable of other embodiments and of being practiced and carried out in various ways. Also, it is to be understood that the phraseology and terminology employed herein are for the purposes of description and should not be regarded as limiting the claims.

Accordingly, those skilled in the art will appreciate that the conception upon which the application and claims are based may be readily utilized as a basis for the design of other structures, methods, and systems for carrying out the several purposes of the embodiments and claims presented in this application. It is important, therefore, that the claims be regarded as including such equivalent constructions.

Furthermore, the purpose of the foregoing Abstract is to enable the U.S. Patent and Trademark Office and the public generally, and especially including the practitioners in the art who are not familiar with patent and legal terms or phraseology, to determine quickly from a cursory inspection the nature and essence of the technical disclosure of the application. The Abstract is neither intended to define the claims of the application, nor is it intended to be limiting to the scope of the claims in any way. It is intended that the application is defined by the claims appended hereto.

What is claimed is:

1. An invertible pet feeder apparatus, the apparatus comprising:
a pair of containers comprising a first container and a second container, the first container releasably attachable to the second container via an attachment means and forming a stacked relationship between the first container and the second container, and wherein each of the first container and the second container comprises an interior cavity for storing food or water, and wherein each of the first container and the second container comprises a lid detachably secured to a lip of each the first container and the second container.

2. An invertible pet feeder apparatus comprising:
a pair of containers comprising a first container and a second container, the first container releasably attachable to the second container via an attachment means and forming a stacked relationship between the first container and the second container;
each of the first container and the second container comprises a transparent base member having an outer periphery from which a sidewall integrally extends upwardly and forming an interior cavity, and wherein the sidewall terminates in a lip forming an open top in fluid communication with the interior cavity; and
each of the first container and the second container comprises a lid detachably secured to the lip, wherein each lid comprises a non-skid material.

3. The apparatus of claim 2 further comprising at least one additional container interchangeable with either the first container and the second container.

4. The apparatus of claim 2 further comprising a partition insertable into either the first container or the second container.

5. The apparatus of claim 2 further comprising indicia disposed on an exterior surface of at least one of the first container and the second container.

6. The apparatus of claim 2 further comprising indicia disposed on an exterior surface of the lid at least one of the first container and the second container.

7. The apparatus of claim 2, wherein the attachment means couples and decouples the first container and the second container via mechanical fasteners.

8. The apparatus of claim 2, wherein the attachment means couples and decouples the first container and the second container via hook-and-loop material.

9. The apparatus of claim 2, wherein the attachment means is adapted for coupling and decoupling the first container and the second container via mateable threads.

10. The apparatus of claim 2, wherein the non-skid material covers a sufficient surface area on an obverse surface of each lid so as to prevent excessive movement of the apparatus during use.

11. The apparatus of claim 2, wherein at least one of the first container and the second container comprises an adjustable diameter.

12. An invertible pet feeder apparatus comprising:
a pair of containers comprising a first container and a second container, the first container releasably attachable to the second container via an attachment means and forming a stacked relationship between the first container and the second container measuring at least 4.00 inches in height, and wherein each of the first container and the second container is at least 6.25 inches in width;
each of the first container and the second container comprises a transparent base member having an outer periphery from which a sidewall integrally extends upwardly and forming an interior cavity, and the sidewall terminates in a lip forming an open top in fluid communication with the interior cavity;
indicia disposed on at least one of the outer periphery of the first container and the second container; and
each of the first container and the second container comprises a lid detachably secured to the lip, wherein each lid comprises non-skid material disposed on an obverse surface thereof in a quantity sufficient for inhibiting excessive movement of the apparatus during use.

13. The apparatus of claim 12 further comprising at least one additional container interchangeable with either the first container and the second container.

14. The apparatus of claim 12 further comprising a partition insertable into at least one of the first container and the second container.

15. The apparatus of claim 12 further comprising a plurality of partitions insertable into at least one of the first container and the second container.

16. The apparatus of claim 12, wherein the attachment means couples and decouples the first container and the second container via mechanical fasteners.

17. The apparatus of claim 12, wherein the attachment means couples and decouples the first container and the second container via hook-and-loop material.

18. The apparatus of claim 12, wherein the attachment means couples and decouples the first container and the second container via mateable threads.

19. The apparatus of claim 12, wherein at least one of the first container and the second container comprises an adjustable diameter.
